(19) United States
(12) Patent Application Publication
(10) Pub. No.: US 2015/0232139 A1
(43) Pub. Date: Aug. 20, 2015

(54) HITCH SYSTEM WITH LIMITED OSCILLATION

(71) Applicant: CATERPILLAR PAVING PRODUCTS INC., Brooklyn Park, MN (US)

(72) Inventors: Paul S. Petersen, Maple Grove, MN (US); Michael P. Siers, Big Lake, MN (US); Joseph A. Lehtola, Buffalo, MN (US)

(73) Assignee: CATERPILLAR PAVING PRODUCTS INC., Brooklyn Park, MN (US)

(21) Appl. No.: 14/702,783

(22) Filed: May 4, 2015

(51) Int. Cl. B62D 53/02

(52) U.S. Cl. CPC B62D 53/021

(57) ABSTRACT

A hitch system between a first portion and a second portion of a machine includes a first frame with the first portion and a second frame with the second portion. A first axis is disposed along the machine's length and second axis along the machine's height. A link rotatably connects to the first frame at a first ball joint portion and the second frame at a second ball joint portion. A handlebar with the first frame includes a third ball joint portion, which is co-axial with the first axis and the second axis, and to which a coupler link is rotatably connected. The coupler link includes an oscillation restrictor pin. A relative play between an intermediary link with the first frame and the oscillation restrictor pin facilitates a restricted oscillation between the first portion and the second portion of the machine.

### TECHNICAL FIELD

The present disclosure relates generally to hitch systems in construction machines. More specifically, the present disclosure relates to a hitch system that includes a three-point connection to provide a limited articulation and oscillation between a first portion and a second portion of a construction machine.

### BACKGROUND

Hitch systems in construction machines, such as ones with split chassis, generally provide a varying degree of rotation between a first portion and a second portion of the construction machine. An example of one such machine is a utility compactor. Conventional hitch systems in such machines are generally known to provide an articulation feature and an oscillation feature between the two machine portions. The articulation feature generally allows the machine to be freely steerable over a work site, while the oscillation feature allows the machine to freely move over an uneven surface, and accommodate shocks sustained during an operation.

However, conventional hitch systems generally bear an absence of an oscillation restrictor. An oscillation restrictor may be applicable in a single point-of-lift application. For example, a single point-of-lift application normally involves a lift of the construction machine for service, transport, and maintenance. In such applications, it may happen that the machine is coupled to an associated lift mechanism by the first portion. An absence of an oscillation restrictor may subject the second portion to an unbalanced coupling force that may cause the second portion to uncontrollably swivel relative to the first portion. This is undesirable as such swiveling motion may strain the hitch system and the machine and result in component and/or machine failures.

U.S. Pat. No. 2,757,020 discloses an implement attaching structure for tractors and particularly a hitch mechanism to adjustably connect an implement to a draft source. Although this reference provides a mechanism used to attach structures in machines to compensate for a side draft encountered during operations, a solution to accommodate limited oscillatory movement between the machine and a trailer unit is not provided.

Accordingly, the system and method of the present disclosure solves one or more problems set forth above and/or other problems in the art.

### SUMMARY OF THE INVENTION

Various aspects of the present disclosure illustrate a hitch system for limited oscillatory connection between a first portion and a second portion of a machine. The machine includes a first axis disposed along a length of the machine and a second axis disposed along a height of the machine. The first axis is perpendicular to the second axis. The hitch system includes a first frame fixedly connected to the first portion, a second frame fixedly connected to the second portion. A link rotatably connects to the first frame at a first ball joint portion and the second frame at a second ball joint portion. Further, a handlebar is fixedly connected to the first frame and extends substantially towards the second frame. The handlebar includes a third ball joint portion. This third ball joint portion is co-axial with the first axis and the second axis. A coupler link is fixedly connected to the second frame and rotatably connected to the handlebar at the third ball joint portion. The coupler link includes an oscillation restrictor pin. The oscillation restrictor pin has a link engagement surface. The oscillation restrictor pin is co-axially disposed with the third ball joint portion. Furthermore, an intermediary link is fixedly connected to the first frame and includes a restrictor aperture with a pin retainer portion. The link engagement surface is retained within the pin retainer portion and defines a clearance space with the pin retainer portion, which facilitates a relative play between the intermediary link and the oscillation restrictor pin. This relative play allows an oscillatory movement between the first portion and the second portion of the machine, about the first axis. This oscillatory movement is restricted within a first predefined angular range upon contact of the link engagement surface with the pin retainer portion.

### BRIEF DESCRIPTION OF THE DRAWINGS

FIG. 1 is a side view of construction machine installed with an exemplary hitch system between a first portion and second portion of the machine, in accordance with the concepts of the present disclosure;

FIG. 2 is a perspective view of the hitch system of FIG. 1, which is inclusive of a first frame and a second frame, in accordance with the concepts of the present disclosure;

FIG. 3 is a cross-sectional side view of the hitch system of FIG. 1, in accordance with the concepts of the present disclosure;

FIG. 4 is an exemplary partially broken out top view of the hitch system of FIG. 1, depicting an oscillation movement between the first frame and the second frame about an axis X-X′, in accordance with the concepts of the present disclosure; and

FIG. 5 is an exemplary top view of the hitch system of FIG. 1, depicting an articulation movement between the first frame and the second frame, along an axis (not shown) perpendicular to the axis X-X′, in accordance with the concepts of the present disclosure.

### DETAILED DESCRIPTION

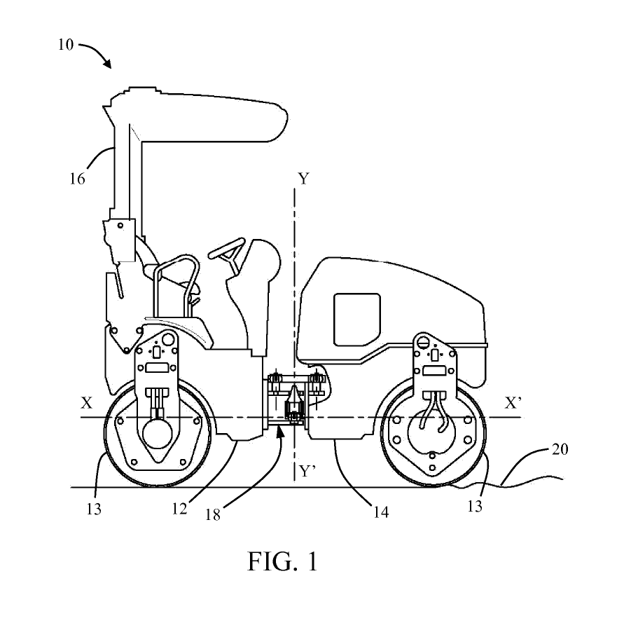

FIG. 1 shows a machine 10. The machine 10 may be a construction machine, such as, but not limited to, a utility compactor. However, an application of the present disclosure may extend to other compactor machines that are employed in applications involving larger scales of operation. Machines that have a trailer configuration, such as articulated trucks, may also employ one or more aspects of the present disclosure. The machine 10 may be associated with road construction, waste management, agriculture, general engineering and construction applications, and/or other industrial practices. Concepts of the present disclosure may also extend to systems and sub-systems within other machines employed in domestic and commercial use.

The machine 10 includes a first portion 12 and a second portion 14. The first portion 12 may accommodate an operator cab 16 from where an operator may operate the machine 10 over a work surface 20. Both the first portion and the second portion may include compactor implements 13 to perform a compacting operation. A hitch system 18 rotatably connects the first portion 12 to the second portion 14. Such a configuration provides a limited oscillatory connection between the first portion 12 and the second portion 14 of the machine 10. The machine 10 includes a first axis X-X′, disposed along a length of the machine 10, and a second axis Y-Y′ disposed along a height of the machine 10. The first axis X-X′ may be a horizontal axis of the machine 10, while the second axis Y-Y′ may be a vertical axis of the machine 10. Effectively, the first axis X-X′ is perpendicular to the second axis Y-Y′.

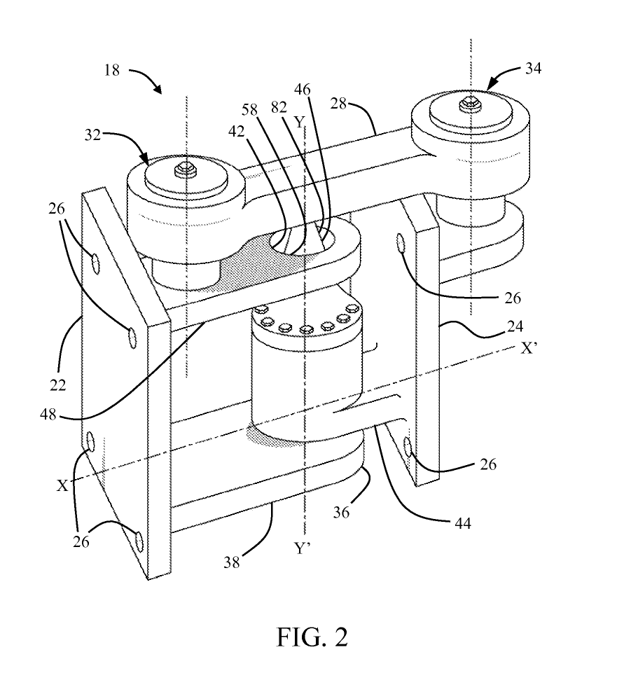

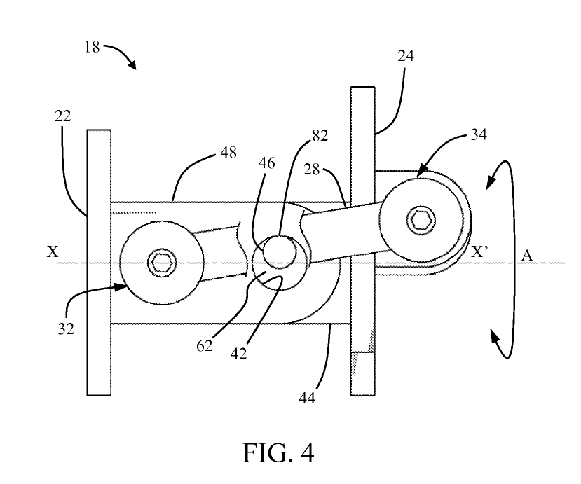

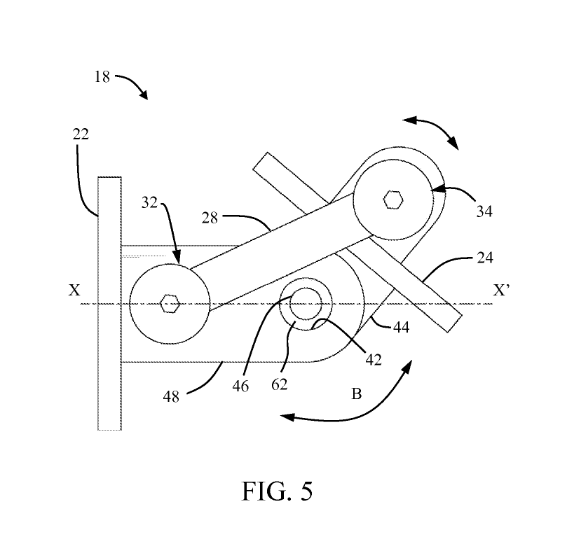

Referring to FIG. 2, an enlarged perspective view of the hitch system 18 is shown. Referring to FIGS. 1 and 2, the hitch system 18 includes a first frame 22 and a second frame 24. The first frame 22 is fixedly connected to the first portion 12 of the machine 10 and the second frame 24 is fixedly connected to the second portion 14 of the machine 10. Both the first frame 22 and the second frame 24 (or simply frames 22, 24) are generally planer components, although other configurations are possible. The frames 22, 24 are positioned substantially parallel to each other when the machine 10 is positioned with the first portion 12 and the second portion 14, linearly aligned to each other, along the first axis X-X′. This may also be applicable when the machine 10 negotiates a linear movement, along a straight path. However, on occasions when the machine 10 negotiates a turn or sustains operations over an uneven work surface 20, at least one of an articulation and an oscillation between the frames 22, 24 is observed (FIGS. 4 and 5).

Further, the frames 22, 24 may include fastener holes 26 to enable connection with the first portion 12 and second portion 14 of the machine 10. However, the hitch system 18 may be mounted relative to the first portion 12 and the second portion 14 of the machine 10 (FIG. 1), possibly by welding.

The hitch system 18 includes a series of linkages operably connected between the first frame 22 and the second frame 24. These linkages facilitate limited oscillation of the first portion 12 relative to the second portion 14 of machine 10. Linkages include a link 28, a handlebar 38, an intermediary link 48, and a coupler link 44.

The link 28 is rotatably connected relative to the first frame 22 at a first ball joint portion 32 and rotatably connected relative to the second frame 24 at a second ball joint portion 34. In so doing, the link 28 establishes a flexible and rotatable connection between the first frame 22 and the second frame 24.

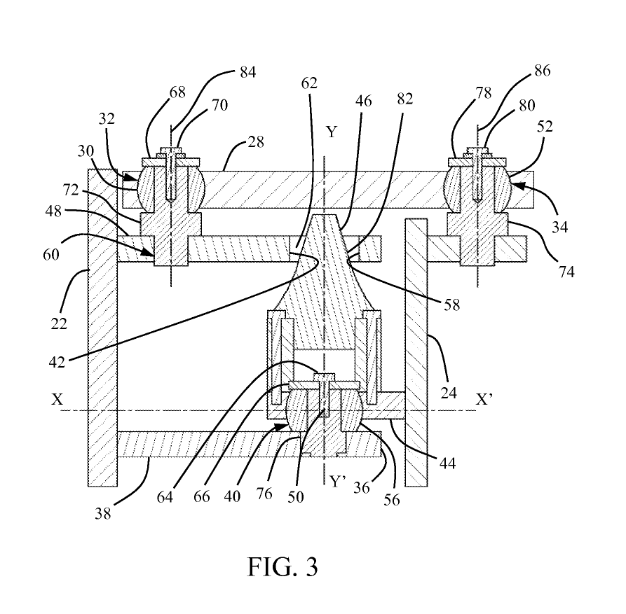

Referring to FIGS. 2 and 3, the handlebar 38 is fixedly connected to the first frame 22. Structurally, the handlebar 38 extends substantially towards the second frame 24. The handlebar 38 includes a third ball joint portion 40 (FIG. 3) assembled adjacent an end 36 of the handlebar 38, which is defined against the second frame 24. In deployment, the third ball joint portion 40 (FIG. 3) is co-axial with the first axis X-X′ and the second axis Y-Y′. Effectively, the third ball joint portion 40 is positioned at an intersection point 50 (FIG. 3), defined between the first axis X-X′ and the second axis Y-Y′, as shown. Notably, the Y-Y′ axis may be envisioned as being further split up or divided into two different axis, namely, a third axis (not shown) and a fourth axis (not shown), during operations. The third axis is defined by the center point of the first ball joint portion 32 and the center point of the third ball joint portion 40, while the fourth axis is defined by a center point of the second ball joint portion 34 and a center point of the third ball joint portion 40. Each of the first frame 22 and the second frame 24 will rotate respectively around the third axis and fourth axis. In effect, these axes are defined by the three ball joint portions 32, 34, and 40, in a triangular pattern.

The intermediary link 48 is positioned between the link 28 and the handlebar 38, and operably extends between the first frame 22 and the second frame 24. The intermediary link 48 is also fixedly connected with the first frame 22, and extends towards the second frame 24. The intermediary link 48 includes a restrictor aperture 42 with a pin retainer portion 58, as shown. The pin retainer portion 58 may embody an inner peripheral region of the restrictor aperture 42. The restrictor aperture 42 may be co-axial with the third ball joint portion 40 (FIG. 3) along the second axis Y-Y′. However, if the machine 10 articulates or oscillates, this co-axial alignment may be disabled. Further, the intermediary link 48 includes a joint connection portion 60 that facilitates a fixed connection of the first ball joint portion 32 relative to the first frame 22. This in turn establishes the rotatable connection of the link 28 relative to the first frame 22, via the first ball joint portion 32.

The coupler link 44 may be fixedly connected to the second frame 24. The coupler link 44 extends from the second frame 24 towards the first frame 22, and is rotatably connected to the handlebar 38 at the third ball joint portion 40 (FIG. 3). The coupler link 44 includes an oscillation restrictor pin 46, which is co-axially disposed with the third ball joint portion 40, along the second axis Y-Y′. The oscillation restrictor pin 46 may be fixedly bolted to the coupler link 44. The oscillation restrictor pin 46 is adapted to halt an oscillatory movement between the first portion 12 and the second portion 14 within a predefined angular range.

Further, the oscillation restrictor pin 46 includes a link engagement surface 82 that extends through the restrictor aperture 42. Accordingly, the link engagement surface 82 is retained within the pin retainer portion 58. However, a clearance space 62 exists between the link engagement surface 82 and the pin retainer portion 58 of the restrictor aperture 42. This clearance space 62 facilitates a relative play between the intermediary link 48 and the oscillation restrictor pin 46, thereby facilitating limited relative play between the first portion 12 and the second portion 14 of the machine 10. Structurally, the oscillation restrictor pin 46 may include a conical profile, as shown. However, multiple other profiles may be contemplated. When the machine 10 is stationed over a flat surface (or when an oscillation between the first portion 12 and the second portion 14 is absent), it may be envisioned that the oscillation restrictor pin 46 extends co-axially through the restrictor aperture 42, along the second axis Y-Y′.

A connection of the handlebar 38 and the intermediary link 48 to the first frame 22 may be contemplated, via welded engagement. However, other connection means, such as bolted arrangements may also be contemplated. Moreover, each of the linkages, namely the link 28, the handlebar 38, the intermediary link 48, and the coupler link 44, are substantially parallel to each other. Additionally, these linkages and are substantially, perpendicularly deployed relative to the first frame 22 and the second frame 24. Accordingly, these linkages are also parallel to the first axis X-X′ of the machine 10, in deployment.

Referring to FIG. 3, the substantial parallel deployment of the linkages relative to each other, and a substantial perpendicular deployment of the linkages relative to the frames 22, 24 may be further envisioned. Moreover, a three-point connection formed by the ball joint portions 32, 34, 40, is also shown by means of a cross-sectional side view of the hitch system 18. This three-point connection permits the first frame 22 (with the first portion 12) to be manipulated about both the first axis X-X′ and second axis Y-Y′ relative to the second frame 24 (with the second portion 14). Moreover, each of the ball joint portions 32, 34, 40 respectively includes a first ball joint member 30, a second ball joint member 52, and third ball joint member 56, as shown. Ball joint members 30, 52 respectively include a first rotation axis 84 and a second rotation axis 86. In assembly, ball joint members 30, 52 generally form an interface between each of a first pin 72 and a second pin 74, and the link 28, as shown. Similarly, the ball joint member 56 forms an interface between a third pin 76 and the handlebar 38. With this configuration, the pins 72, 74, and 76 facilitate flexibility and rotation at the associated connections. In effect, this configuration provides a limitedly flexible inter-connected link arrangement between the first frame 22 and the second frame 24.

The ball joint portions 32, 34 respectively include a first retainer washer 68 and a second retainer washer 78 (or simply washers 68, 78). In addition, the ball joint portions 32, 34 respectively also include a first retainer bolt arrangement 70 and a second retainer bolt arrangement 80 (or simply bolt arrangements 70, 80). Although not limited, washers 68, 78 and the bolt arrangement 70, 80 may be similar in form and function. The bolt arrangements 70, 80 generally axially retain an engagement of the pins 72, 74 with the link 28. Similarly, the third ball joint portion 40 (FIG. 3) includes a third retainer washer 66 and a third retainer bolt arrangement 64, which axially retains the third pin 76 relative to the handlebar 38.

Referring to FIG. 4, a partially broken out top view of an exemplary operational perspective of the hitch system 18 is shown. FIG. 4 is discussed in conjunction with FIG. 1. The exemplary event of an oscillation of the first portion 12 relative to the second portion 14 (or between the first frame 22 and the second frame 24), during an exemplary single point-of-lift application, is shown. This oscillation event occurs when the coupler link 44 rotates over the ball joint member 56 (FIG. 3) about the first axis X-X′. More particularly, this oscillation event (direction, A) occurs due to the relative play (clearance space 62) that exists between the intermediary link 48 and the oscillation restrictor pin 46. However, the oscillatory movement is restricted within a first predefined angular range upon a contact of the link engagement surface 82 with the pin retainer portion 58 (FIG. 3). An associated predefined angular range may vary from application to application. Further, the first predefined angular range may depend upon a difference between a diameter of the restrictor aperture 42 and the diameter of the oscillation restrictor pin 46.

Referring to FIG. 5, a top view of another operational perspective of the hitch system 18 is shown. FIG. 5 is discussed in conjunction with FIG. 1. As shown, an exemplary event of an articulation of the first portion 12 relative to the second portion 14 (or between the first frame 22 and the second frame 24), is shown. This articulation event occurs generally about the second axis Y-Y′. More particularly, this angular movement facilitates a relative manipulation between the first ball joint portion 32, the second ball joint portion 34, and the third ball joint portion 40. A steering cylinder (not shown) generally accomplishes a limitation in said articulation.

### INDUSTRIAL APPLICABILITY

In operation, it may be required to lift the machine 10 along the second axis Y-Y′. This may be accomplished via a system (not shown) that applies a single point-of-lift principle for the associated lifting operation. In such situations, the system (not shown) may tie to a first portion of the machine 10. As a lifting operation is initiated, the first portion 12 may assume a fixed relation with the affiliated lifting mechanism. However, the second portion 14, which is left free relative to the lifting system (not shown), may be subject to a coupling force. As a result, the second portion 14 may at least tilt about one of the first axis X-X′ and the second axis Y-Y′.

Referring to FIG. 4, the first frame 22 is at an angle to the second frame 24, about the first axis X-X′. As depicted, the oscillation restrictor pin 46 facilitates a stop or a restriction to the oscillation event within the first predefined angular range, which may be a non-limited quantity that varies from application to application, as noted above. As an example, in a single point-of-lift application the first portion 12 may oscillate (or tilt) relative to the second portion 14 (direction, A). Given this condition, the oscillation restrictor pin 46 tilts to move out of alignment relative to the second axis Y-Y′, and abuts against the pin retainer portion 58. Upon an associated contact of the link engagement surface 82 with the pin retainer portion 58, a further oscillation of the first portion relative to the second portion is halted. As another example, this configuration may be assumed when the machine 10 (FIG. 1) is steered above the work surface 20 and is subject to the undulations of an uneven terrain. Further, a limiting factor for rotation (FIG. 5) around the second axis Y-Y′ may be defined by a length of an associated steering cylinder (not shown).

It should be understood that the above description is intended for illustrative purposes only and is not intended to limit the scope of the present disclosure in any way. Thus, those skilled in the art will appreciate that other aspects of the disclosure may be obtained from a study of the drawings, the disclosure, and the appended claim.

What is claimed is:

1. A hitch system for a limited oscillatory connection between a first portion and a second portion of a machine, the machine including a first axis disposed along a length of the machine and a second axis disposed along a height of the machine, the first axis being perpendicular to the second axis, the hitch system comprising:
a first frame fixedly connected to the first portion;
a second frame fixedly connected to the second portion;
a link that rotatably connects relative to the first frame at a first ball joint portion and rotatably connects relative to the second frame at a second ball joint portion;
a handlebar fixedly connected to the first frame, extending substantially towards the second frame, and including a third ball joint portion, wherein the third ball joint portion is co-axial with the first axis and the second axis;
a coupler link fixedly connected to the second frame and rotatably connected to the handlebar at the third ball joint portion, the coupler link including an oscillation restrictor pin, the oscillation restrictor pin having a link engagement surface and being co-axially disposed with the third ball joint portion; and
an intermediary link fixedly connected to the first frame and including a restrictor aperture with a pin retainer portion,
wherein the link engagement surface is retained within the pin retainer portion and defines a clearance space with the pin retainer portion that facilitates a relative play between the intermediary link and the oscillation restrictor pin,
wherein the relative play between the intermediary link and the oscillation restrictor pin facilitates an oscillatory movement between the first portion and the second portion of the machine, about the first axis, the oscillatory movement being restricted within a first predefined angular range upon a contact of the link engagement surface with the pin retainer portion.
